(19) United States
(12) Patent Application Publication
(10) Pub. No.: US 2017/0033925 A1
(43) Pub. Date: Feb. 2, 2017

(54) METHODS AND APPARATUS FOR IMPLEMENTING A COMMUNICATIONS SYSTEM SECURED USING ONE-TIME PADS

(71) Applicant: Oscar Tango Papa LLC, New York, NY (US)

(72) Inventors: John Paul DeNeut, Maple Grove, MN (US); Thomas Day Newbold, Prague (CZ)

(73) Assignee: Oscar Tango Papa LLC, New York, NY (US)

(21) Appl. No.: 15/303,425

(22) PCT Filed: Apr. 10, 2015
(86) PCT No.: PCT/US15/25455

§ 371 Date: Oct. 11, 2016

Related U.S. Application Data
(60) Provisional application No. 61/978,771, filed on Apr. 11, 2014.

(51) Int. Cl. H04L 9/08; G06K 7/10; G06K 7/14; H04L 9/32; H04L 9/06

(52) U.S. Cl. CPC H04L 9/0819; H04L 9/0869; H04L 9/3228; H04L 9/0631; H04L 9/3242; G06K 7/1417; G06K 7/10722

(57) ABSTRACT

The present invention relates generally to mechanisms for securing a communication system by using one-time pads. One-time pads may be generated and exchanged in person using proximity based mechanisms including optical communication mechanisms on mobile devices. In particular examples, a quick response (QR) code on one party's mobile device is scanned by the other party's mobile device to securely exchange a randomly-generated symmetric key. The symmetric key is used to encrypt a randomly generated one-time pad transmitted from one party's mobile device to the other party's mobile device. The one-time pad may be shared in encrypted form using proximity based mechanisms including Bluetooth, WiFi, etc.

### CROSS-REFERENCE TO RELATED APPLICATIONS

This application claims the benefit under 35 U.S.C. §119(e) of U.S. Provisional Patent Application 61/978,771, entitled: “METHODS AND APPARATUS FOR IMPLEMENTING A COMMUNICATIONS SYSTEM SECURED USING ONE-TIME PADS”, filed on Apr. 11, 2014, which is incorporated herein by reference in its entirety.

### TECHNICAL FIELD

The present disclosure relates to securing communications by using one-time pads.

### DESCRIPTION OF RELATED ART

Various conventional mechanisms are available for securing digital communications. However, each of these conventional mechanisms has drawbacks. For example, public key cryptography or asymmetric cryptography attempts to provide both confidentiality and authentication. A message is encrypted with a receiver's public key and cannot be decrypted by anyone who does not possess the corresponding private key. Confidentiality is provided because the only person who can presumably decrypt the message is the owner of the private key. A message can be authenticated by signing the message with the sender's private key. The authenticity of the message can be verified by anyone with access to the sender's public key. However, public key cryptography can be computationally expensive and is often extremely complicated to setup and maintain, particularly for average users who have limited understanding of asymmetric cryptography. Furthermore, public key cryptography is based on difficult to solve mathematical problems that have difficult to exploit but known vulnerabilities. Furthermore, although the mathematical problems may be difficult to solve currently, they may not always be as difficult to solve or compromise.

Symmetric key cryptography can use the same key in stream or block ciphers to encrypt and decrypt data. If a sender and a receiver both have access to the same key, the sender and receiver can theoretically maintain a private and secure information link. In many instances, public key cryptography is used to exchange symmetric keys between a sender and a receiver. Both the sender and receiver must have access to the shared key. However, because the shared key is reused, symmetric key cryptography becomes increasingly vulnerable to attacks in leaky systems, where not only ciphertext is obtained, but plaintext corresponding to portions of the ciphertext are known and can be used to implement attacks more efficient than brute force attacks.

One-time pads are an encryption technique that cannot be broken if used correctly. Plaintext is encrypted using a one-time pad or one-time use key. If the one-time pad is truly random and never reused, the resulting ciphertext has been mathematically shown to be impossible to decrypt. Brute force attacks on ciphertext using all possible pads simply yields all possible plaintext. Furthermore, even if a portion of the plaintext is known, no information is gleaned about other parts of the pad needed to decrypt the rest of the plaintext. However, in practical situations, one-time pads are difficult to use because it is extremely difficult to generate and share one-time pads in a secure manner. If pads are shared over networks, the one-time pad encryption technique would only be as secure as the public key or symmetric key algorithm used to share the one-time pad. If pads are reused or not sufficiently random, the encryption technique becomes much more vulnerable to cryptanalysis.

Although conventional mechanisms for securing digital communications are effective in a number of circumstances, it is desirable to provide improved mechanisms for securing digital communications in a manner that significantly decreases the vulnerabilities and deficiencies inherent in conventional systems. Accordingly, improved methods and apparatus are described for providing secure communications using one-time pads.

### OVERVIEW

The present invention relates generally to mechanisms for securing a communication system by using one-time pads. One-time pads may be generated and exchanged in person using proximity based mechanisms including optical communication mechanisms on mobile devices. In particular examples, a quick response (QR) code on one party's mobile device is scanned by the other party's mobile device to securely exchange a randomly-generated symmetric key or public key from a public-key, private-key pair. The symmetric key (or alternately, public key) is used to encrypt a randomly generated one-time pad transmitted from one party's mobile device to the other party's mobile device. The one-time pad may be shared in encrypted form using proximity based mechanisms including Bluetooth, WiFi, etc.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates one example of a user-to-user direct scenario communication system.

FIG. 2 illustrates one example of a routing configuration scenario communication system.

FIG. 3 illustrates one example of a mechanism for avoiding collisions.

FIG. 4 illustrates one example of a group pad mechanism.

FIG. 5 illustrates one example of a device.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular devices. However, it should be noted that the techniques of the present invention apply to a wide variety of different device including wearable devices, portable devices, computer systems, mobile device, etc. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Various aspects of the present invention relate generally to systems and methods for implementing a communications system secured by using one-time pads. Existing communications applications and networks such as email, instant messaging applications, and SMS have varying degrees of deficiency in securing the communications/message traffic that traverses insecure networks such as the public Internet. Existing applications and networks, to the extent they incorporate encryption for security, are difficult for the average user to understand and, given enough computing power, are susceptible to code breaking. For example, various conventional mechanisms rely on complex and computationally demanding public key, private key algorithms to secure communications between and among users, which make them hard for users to understand. Securing email communications entails using a complex “digital certificate” that requires implementation in client software (which is often confusing and time consuming) in combination with public key, private key algorithms. With enough computing resources and time, public key, private key encryption algorithms are susceptible to being broken by cryptanalysis. One-time pad-based systems have traditionally been limited to military and diplomatic applications because of the perceived difficulty of managing such systems.

According to various embodiments of the present invention, one-time pads are efficiently managed to allow use in securing communications and message traffic such that only the sender and the receiver are able to read the message (text, photo, video, and other file formats). If used correctly, one-time pads have been mathematically shown to provide unbreakable encryption. In particular embodiments, one-time pads are efficiently managed so that sharing and usage of one-time pads is coordinated in a highly scalable manner that minimizes the potential for collisions. Through the in-person nature of the key exchange, various embodiments give the normally abstract concept of trust a physical manifestation that is easy for users to relate to and understand.

Various embodiments of the one-time pad system provide unbreakable security if used properly, simplicity and understandability, ease of use, and scalability. The complexity of creating, sharing, and managing one-time pad “keys,” is virtually invisible to the user. The in person exchange of keys is reduced to the press of a button and/or a scan of a code. Efficient key management allows various embodiments of the one-time pad system to scale while minimally relying on central server communication and coordination. The computational efficiency of encoding and decoding messages with one-time pads makes it possible for the service to be available for use on a wide range of devices and ensures fast response time from the service.

According to various embodiments, a one-time pad system extends existing networks of trust between people “in real life” into the digital realm, in a simple and understandable way. Specifically, messages transmitted between users are protected by using unbreakable encryption keys that people exchange easily in person using mechanisms such as their mobile devices. Once users have exchanged keys or one-time pads in person, they can send perfectly secure messages back and forth using the one-time pad system. The encryption keys allow for thousands of text message and photo (and additional file formats) message transfers before needing to be renewed, typically through another in-person meeting.

The one-time pad technique of securing communications is well known to be perfectly secure if the communicating parties (1) share a pad having a set of truly random numbers, (2) keep the pad secure, and (3) use the pad only once to encrypt data (i.e. no pad re-use). The use of one-time pad systems has been limited because of a variety of constraints, many of which are overcome using various embodiments of the present invention.

Current mobile devices contain random number generating and/or pseudo random number generating capabilities (RNG), large amounts of storage space, file system encryption, capable cameras, and multiple radio communication options (Bluetooth, WiFi, 3G, LTE, etc.). In particular embodiments, a one-time pad system leverages random number generation to create large, e.g. 500 KB-100 MB, one-time pads that are stored securely on mobile devices, optical connections (via the camera) and local wireless network connections to securely exchange one-time pads between users in person, and the built-in device file system encryption to secure the encryption data used by the one-time pad system application.

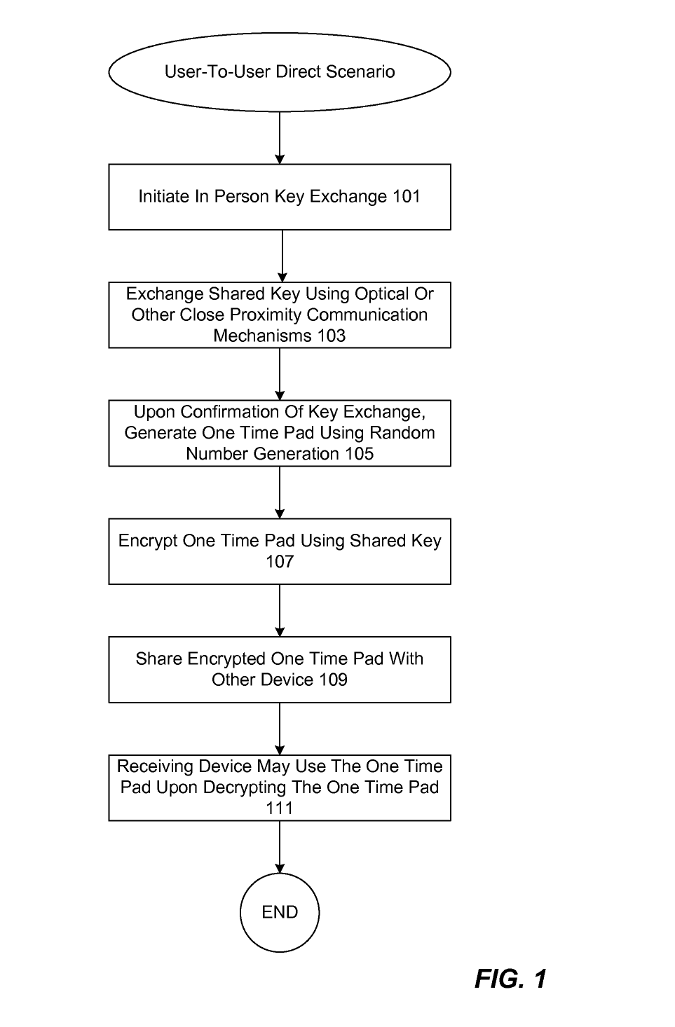

FIG. 1 illustrates one example of usage of a one-time pad generation and exchange mechanism in a user-to-user direct scenario. According to various embodiments, users meet in person with their mobile devices, download and install the one-time pad system client app (if they have not already done so), and start the one-time pad system client app. According to various embodiments, User 1 clicks the button in the app called “Display a code to another user,” which brings up a QR code on User 1's screen that includes an encryption key (either symmetric AES 256 bit or asymmetric), and HMAC key for authentication, various metadata (including device and network information) and a value to be used as a session token. The in-person key exchange is a physical embodiment (simple, visible and fun) of the digital communication that is used to establish the one-time pad system bond of trust.

At 101, an in person key exchange is initiated. According to various embodiments, once the “Display a code to another user” button is clicked by User 1, User 1's one-time pad system app displays a QR code which contains a unique, randomly-generated AES 256 bit key (generated on the fly by the app using the RNG, optionally in combination with other sources of random or pseudorandom data) or a public key from a public-key, private-key pair, a 256 bit HMAC key for authentication, a single-use session token and various metadata (including device information). User 2 clicks the button “Scan a code with the camera” which brings up a QR Code scanning screen with a camera window and instructions to scan the other person's QR code. A variety of close proximity communication mechanisms can be used at 103 to exchange a shared key. In particular embodiments, User 1's one-time pad system app, upon User 1 clicking the button “Display a code to another user,” automatically displays a QR code which contains a unique, randomly-generated AES 256 bit key (generated on the fly by the app using the RNG, optionally in combination with other sources of random or pseudorandom data) or a public key from a public-key, private-key pair, a 256 bit HMAC key for authentication, a single-use session token and various metadata (including device and network information), and displays the message “Display this code to another user to exchange keys” Alternatively, User 2 then scans User 1's QR code, receiving the unique AES 256 bit key or a public key from a public-key, private-key pair, a 256 bit HMAC key for authentication, session token, the username and metadata. Upon scan of the QR code (without further intervention from either user), User 2 uses the session token received in the QR code to request keys from User 1's device. Note that the scanning of the QR code is optical communication and not vulnerable to radio frequency sniffing; in order to intercept the unique AES 256 bit key, the “bad guy” would have to literally see (and remotely read) the QR code, or in the case of a public key from a public-key, private-key pair, even if the public key was seen and remotely read by a “bad guy,” the bad guy still would only have the public key.

In particular embodiments, upon QR code scan, and following validation that the session token received in the key request matches the session token exchanged via the QR code, User 2's device, or optionally the most capable device (or both devices), generates a one-time pad using the device's RNG, optionally in combination with other sources of random or pseudorandom data at 105. In addition to the device's RNG pseudorandom number generation at 105, the one-time pad generation process may include other sources of random data (such as camera sensor noise, radio noise, accelerometer and gyroscope data, to name just a few), other stream cipher outputs, in each case such data, an “Additional Random Data Stream,” If Additional Random Data Streams are used in the one-time pad generating process, such Additional Random Data Streams are combined with data from the device's RNG using an “exclusive or” (XOR) operation, in a serial process. Additionally, if the one-time pad data generated by each of the two exchanging devices is to be combined to create the final one-time pad used for encryption, the respective one-time pads generated by each of the devices may be combined using an “exclusive or” (XOR) operation, the result of such XOR operation, a “Combined One-time Pad.” According to various embodiments, User 2's device encrypts the one-time pad using the shared key at 107. In particular embodiments, the encrypted one-time pad is transmitted to User 1 using a local connection such as a Multipeer connection, a Wi-Fi Direct connection, an AirDrop connection, a Bluetooth connection, a local Wifi connection, or other local wireless connection (the “Local Wireless Connection”) at 109. During the key generation, transmission and decryption, a progress indicator may be shown to both users on screen within the one-time pad system app.

The receiving device may use the one-time pad upon decrypting the one-time pad at 111, or optionally upon the completion of the generation of a Combined One-time Pad and the encrypted transmission to the sending device using a Local Wireless Connection. In particular embodiments, once the pad exchange has been completed, each user sees a “Keys exchanged successfully!” message.

Now, with keys securely exchanged, User 1 and User 2 can communicate in a secure manner even over unsecure networks for as long as the pad lasts. According to various embodiments, each message sent “consumes” the same amount of pad as the size of the messaged. After the exhaustion of the pads and until they are able to meet in person to exchange keys securely again, the users can still communicate with a very high level of security using the shared, unique AES 256 bit key which is unique to them.

To send a text message using the one-time pad, User 1 clicks the “create message” button or enters a conversation window for User 2, enters text and clicks send. The one-time pad system app then transforms the cleartext message into “ciphertext” using the one-time pad shared between User 1 and User 2, deletes the portion of the one-time pad that User 1 used to encrypt the message, and sends the ciphertext message to one-time pad system server for delivery to User 2. In various embodiments, the one-time pad system generates the ciphertext by combining each bit or character of the plaintext with the corresponding bit or character from the sub-pad corresponding to the Key ID of the message using an “exclusive or” (XOR) operation. For the avoidance of doubt, (a) all references to encrypting using a one-time pad or transforming plaintext to ciphertext refer to XOR operation of plaintext and Message Key, and (b) all references to decrypting using a one-time pad or transforming ciphertext to plaintext refer to XOR operation of ciphertext and Message Key. The one-time pad system server receives the message for delivery to User 2, and sends the message on to User 2. (Note that only User 1 and User 2 are able to read the contents of the message. Neither the one-time pad system nor any third party would be able to read the contents of the message unless they had the device of User 1 or User 2 containing the one-time pad used to encrypt the message. This means that the message as it is being communicated across networks to the other user is unconditionally secure.

User 2 receives the ciphertext message from User 1. User 2's one-time pad system app then uses its copy of the one-time pad to decrypt the message, by generating the plaintext by combining each bit or character of the ciphertext with the corresponding bit or character from the sub-pad corresponding to the Key ID of the message using an “exclusive or” (XOR) operation. User 2's one-time pad system app deletes the portion of the one-time pad that User 2 used to decrypt the message. User 2's one-time pad system app shows User 2 the message from User 1. It should be noted that the same mechanisms can be applied for sending photos, videos, voice recordings or any arbitrary file type.

If a pair of users is approaching exhaustion of the shared one-time pad that they had previously exchanged, the one-time pad system app may provide warnings such as “only X % key remaining” or “only 15 photos worth of key remaining” and encourage the users to meet again to exchange one-time pads.

To send a photo message using the one-time pad system, User 1 enters a conversation window for User 2, chooses the camera icon to take new picture (and taps “Use Photo”) or chooses the gallery icon to select an existing picture, at which point the one-time pad system app, by default, encrypts the photo, transforming the cleartext photo into “ciphertext” using a single-use AES 256 bit key specifically for that message (the AES 256 bit key and associated 256 bit HMAC key is delivered to the receiver—User 2 in this example—encrypted via one-time pad encryption, with HMAC authentication, and deleted immediately after its use for encrypting the message). This method of encrypting photos (and other file types in the future), referred to as OTP One-Time Key encryption has the advantage of using the one-time pad data far more efficiently than using one-time pad to directly encrypt the photo, while still preserving Forward Secrecy by using a unique key for each message (at least partially compensating for the vulnerability of a symmetrical block cipher to a brute force attack). As a result of this method of encrypting photos and other file types, a single key exchange enables sending text messages and photos interchangeably (in terms of one-time pad key consumption). Optionally the one-time pad system app my include “Advanced Settings” which will enable users to choose one-time pad data encryption for photos and other media files, where sufficient amount of pad is available. The one-time pad system server receives the message for delivery to User 2, and sends the message on to User 2. Note that only User 1 and User 2 are able to read the contents of the message, since one-time pads were used to secure the exchange a one-time-use symmetric encryption key to encrypt the photo (or file). Neither the one-time pad system nor any third party would be able to decode the photo or file unless they had the device of User 1 or User 2 containing the one-time pad used to encrypt the message.

If a pair of users has completely exhausted the shared one-time pad that they had previously exchanged, they will still be able to communicate in a highly secure fashion using the one-time pad system app since they have previously securely exchanged a shared unique AES 256 bit key in person which can be used in combination with MAC Key to secure communication until the users are able to meet again to exchange pads, or since they have exchanged a unique AES 256 bit key and MAC Key over an encrypted Local Wireless Connection using an optically-exchanged public key from a public-key, private-key pair. The more messages the users send each other using the symmetric AES 256 bit keys for encryption, the more vulnerable their AES-only encrypted message traffic becomes to cryptanalysis, so the one-time pad system app may remind users to meet again and may potentially even limit users ability to message using just the AES 256 bit key. It should be noted that each time users exchange keys securely in person, a new unique AES 256 bit key and a new MAC Key are generated using the RNG to secure the key exchange over the Local Wireless Connection and stored within the address book of the app for later use as a fall back encryption method in the case of pad exhaustion.

Because one-time pad system users may optionally be securely synchronized with the user's contact list upon granting of permission, a one-time pad system may be able to optionally display notifications to users that people who are in their contact list and are one-time pad system users are nearby and available for exchanging keys.

In addition to offering the complete end-to-end messaging service including delivery of encrypted messages through the use of the one-time pad system server, the system also enables unconditionally secure communications over other networks at the user's choice and discretion. A user could, as an alternative to using the one-time pad system server, choose an alternate transmission method for the ciphertext message, such as SMS, iMessage, email, telegram, printed letter, Morse code, etc. With “Out-of-Band” choice of message delivery, a user would not need to trust one-time pad system servers even with metadata about messaging traffic since the user can fully manage and control delivery of the ciphertext message. This use of the one-time pad system can be streamlined by the one-time pad system providing built-in options for iMessage/SMS/email delivery (by prepopulating the messages with the ciphertext) and by providing an easy-to-use copy/paste functionality for users to customize delivery. The Out-of-Band message delivery capability would be advantageous particularly in cases where internet data access is unavailable and or unreliable, by enabling secure message transmission capability via SMS. Advantageously, with the Out-of-Band message delivery option, the one-time pad system app can provide the intended receiver of the message an URL-based message format, that can enable one-click decryption of the message by the intended recipient (and only that recipient).

As an additional alternative delivery channel, the one-time pad system could operate using peer-to-peer mesh networks such as the Apple MultiPeer Connectivity Framework, either in a transparent/integrated fashion or enabling users to use such networks for Out-of-Band delivery. In such peer-to-peer mesh networks, there may be concerns about the trustworthiness, behavior and intentions of other peers in the network, making the unconditionally secure transport offered by the one-time pad system particularly valuable. Finally, the authentication capabilities offered by the one-time pad system could be used to establish trusted paths/routes through these types of peer-to-peer mesh networks without necessarily using one-time pad system to ensure end-to-end security of the underlying network communication traffic.

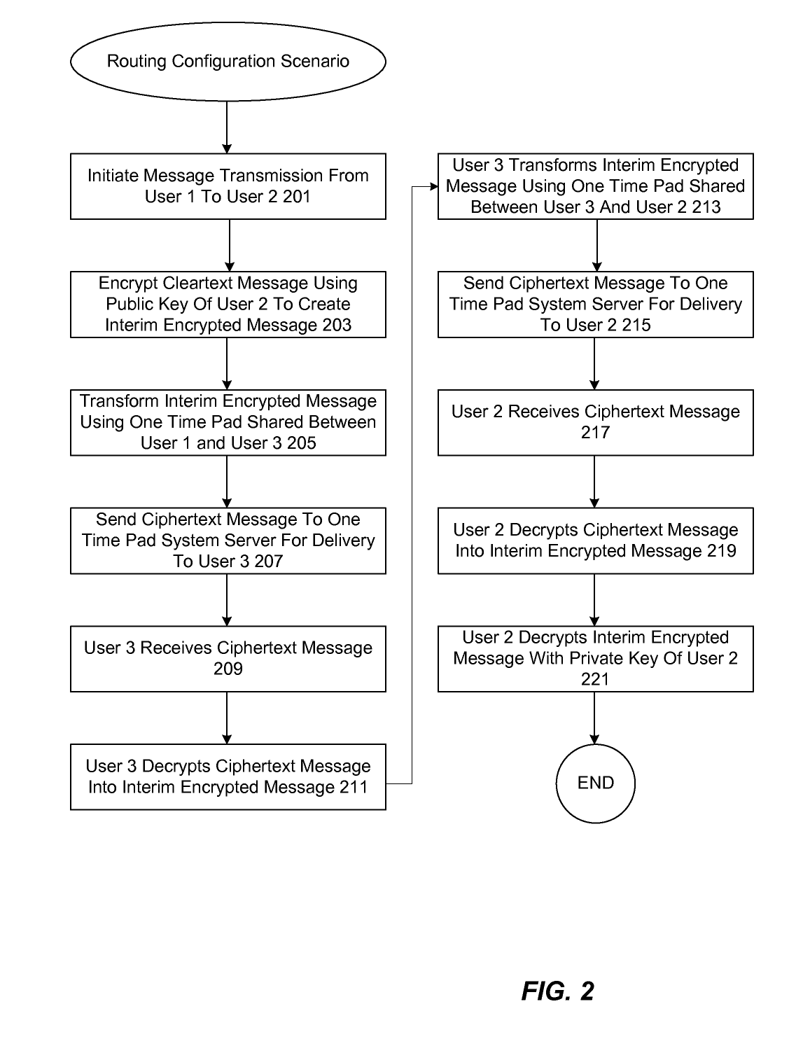

FIG. 2 illustrates one example of a one-time pad system in a routing configuration scenario. In addition to the user-to-user direct configuration, the one-time pad system also allows a routing configuration where a user can communicate with another user without having a shared one-time pad, if the users each have another user in common with whom they have exchanged a shared one-time pad. The following example assumes that User 1 and User 2 want to communicate (they do not share a one-time pad directly) and they both have exchanged shared one-time pads with User 3.

At 201, to send a text message using the one-time pad (routing system), User 1 clicks the “create message” button or enters a conversation window for User 2, enters text and clicks send. The one-time pad system app knows from metadata communication with the one-time pad system server that, even though User 1 and User 2 do not share a one-time pad, a routing path exists through User 3 (for up to a specified amount of data). At 203, User 1's one-time pad system app then encrypts the cleartext message ultimately intended for User 2 using the public key of User 2 using standard public key—private key encryption (the Interim Encrypted Message). At 205, User 1's one-time pad system app transforms the Interim Encrypted Message into “ciphertext” using the one-time pad shared between User 1 and User 3 and deletes the portion of the one-time pad that User 1 used to encrypt the message. Note that the above method works equally well for the OTP One-Time Key encryption of photos and other files.

At 207, User 1's one-time pad system app sends the ciphertext message to one-time pad system server for delivery to User 3 (and further delivery to User 2). The one-time pad system server receives the message for delivery to User 3 (for further delivery to User 2), and sends the message on to User 3. At 209, User 3 receives the ciphertext message from User 1. At 211, User 3's one-time pad system app then uses it's copy of the one-time pad shared between User 1 and User 3 to decrypt the Interim Encrypted Message. User 3's one-time pad system app deletes the portion of the one-time pad that User 3 used to decrypt the Interim Encrypted Message. At 213, User 3's one-time pad system app transforms the Interim Encrypted Message into “ciphertext” using the one-time pad shared between User 3 and User 2 deletes the portion of the one-time pad that User 3 used to encrypt the message. At 215, User 3's one-time pad system app sends the ciphertext message to one-time pad system server for delivery to User 2 (the final recipient).

The one-time pad system server receives the message for delivery to User 2, and sends the message on to User 2 and User 2 receives the ciphertext message from User 3 at 217. At 219, User 2's one-time pad system app then uses its copy of the one-time pad shared between User 3 and User 2 to decrypt the Interim Encrypted Message. User 2's one-time pad system app deletes the portion of the one-time pad that User 2 used to decrypt the message. User 2's one-time pad system app decrypts the Interim Encrypted Message using User 2's private key at 221. User 2's one-time pad system app shows User 2 the message from User 1.

In addition to the routing configuration for users who never had a shared key (but had a third party in common with whom they had both securely exchanged one-time pads), the routing configuration can be used for users who have exhausted their shared one-time pad (and have a third party in common with whom they have both securely exchanged keys). In this case, instead of using public-key, private-key encryption, the users would use their shared, unique AES 256 bit key to encrypt the message in the Interim Encrypted Message step, thus further strengthening the security of the end to end transmission of the message.

According to various embodiments, a message (whether in cleartext or Interim-Encrypted) that is encrypted using a one-time pad is impervious to cryptanalysis while being transported across networks. In a routing configuration, the maximum vulnerability is while the message is decrypted and re-encrypted using one-time pads on User 3's device, however, in all cases, the underlying message will already be in Interim Encrypted form, making it unreadable to User 3 (it is also worth noting that both User 1 and User 2 have explicitly trusted and met User 3 in person to exchange keys). The selection of routes is intended to be invisible to the user, as the one-time pad system server will optimize routing paths (we assume that all exchanged one-time pads are equally trusted) based on factors such as remaining pad size, historical message traffic/pad consumption patterns, and users' expressed preferences/ limits on maximum data transfer for third party routing.

Finally, it should be noted that the routing configuration can be extended from the “one common user” scenario to route messages through multiple intermediaries in the “trust cloud.”

One-time pads also serve as means of authentication since only the two parties have a copy of the same random data, so the simple fact that a user can decrypt a message with a one-time pad shared with another user, ensures that the message was encrypted by that same other user (assuming pad security has been maintained and that message integrity is assured by a MAC). Group messaging can optionally be implemented (a) through the use of bilateral one-time-pads, (b) through the use of bilateral one-time-pads and routing configuration, (c) through the use of group one-time-pads (see below for details), and (d) through any combination of (a) through (c).

In order to maximize the scalability of the system, minimize the coordination required between one-time pad system client apps and the one-time pad system server, and minimize/eliminate the risk of pad collision, the one-time pad creation and management may have a number of characteristics. According to various embodiments, at time of creation of a bilateral one-time pad, the random data generated is not lumped into one giant file, rather the random data is allocated to a group of files (referred to as “sub-pads”) of predetermined (and potentially client-determined based on observed historical messaging patterns) size. These files are assigned a numerical order. The size distribution and number of sub-pads within the one-time pad will be adjusted over time to maximize performance and minimize pad “waste.” In particular embodiments, the sub-pad system is used only internally within the one-time pad system app and is invisible to the users, who only see aggregated pad-level statistics.

Since the random data in the one-time pad can only be used once, a mechanism is required to avoid collision (two users encrypting a message using the same random data from a pad), ideally with minimal coordination between the respective users' clients and little or no reliance on a central sever for coordination.

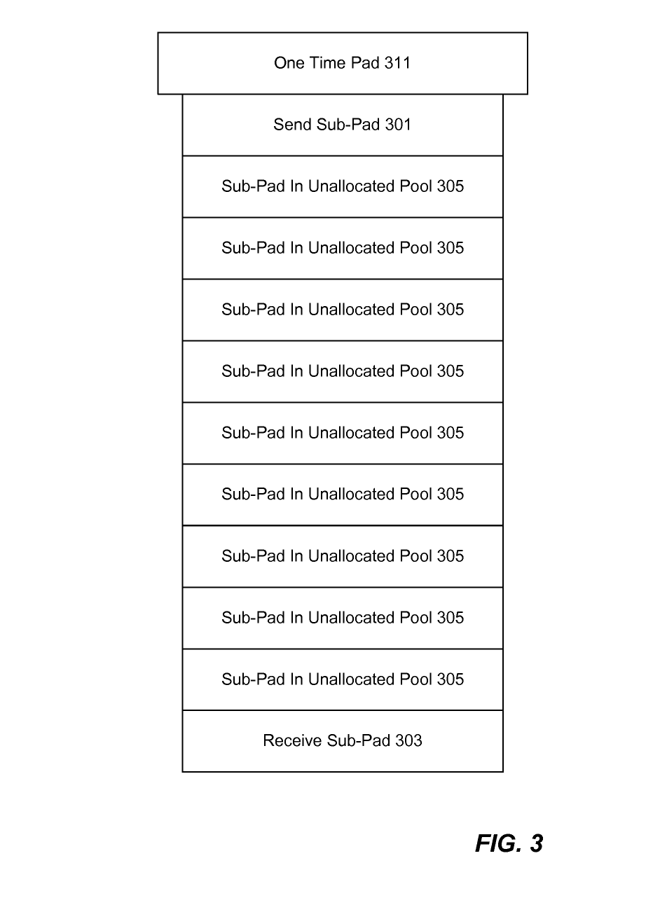

FIG. 3 illustrates one example of a mechanism for avoiding collisions in a one-time pad 311. Many one-time pad systems rely on online synchronization of pointers (starting points), which negatively affects scalability and reliability of such systems. Since there is only one copy of the random data in the pad, one user needs to use part of the random data for encryption (“send pad”) 301 and the other user needs to use the exact same part of the random data for decryption (“receive pad”) 303. According to various embodiments, the one-time pad system allocates the sub-pad at the top of the stack of sub-pads as the “send pad” for one user at 301, and allocates sub-pad at the bottom of the stack of sub-pads as the “send pad” for the other user (such pad consumption direction is established and set at the time of pad exchange), while the rest of the sub-pads initially remain unallocated in a “pool” 305 with an established order of use (by virtue of the numbering system). When sub-pads are created they are assigned an order and numbered from 1 to X for one user, while the other user reverses the order such that its sub-pad X is the other user's sub-pad 1 and vice versa. These ordinal numbers for each sub-pad for each user are persistent. Immediately before encryption at 305, the one-time pad system client app compares the bit size of the message to be encrypted (text, photo, video, etc.) to the remaining bit size of the current sub-pad in use as that user's “send pad;” if the file size is larger than the remaining sub pad size, the user “claims” the next sub-pad in line as a “send pad” (moving down from the top, or up from the bottom depending on the pad configuration for the user). As soon as a user claims the next sub-pad as a “send pad,” the client sends a message to the other client as notice that the other client should not use that sub-pad for sending. However, even if the notice message is not received, the other client will automatically recognize and mark that sub-pad as a “send pad” for the other user as soon as a message is received that has been encrypted with that sub-pad. As long as there is more than one sub-pad left in the “pool,” a user's client is able to claim the next sub-pad in order as a “send pad,” resulting in a maximum of one sub-pad of waste and without requiring any complex rules or central server coordination.

In an alternative embodiment to FIG. 3, the one-time pad system can pre-allocate a portion of the sub-pads as “send pads” for one user and “receive pads” for the other user.

Partially-used sub-pads will continue to be used by the app as “send pads” based on message size fit, such that partially used sub-pads are not automatically wasted. In order to accommodate sending larger files (photos, videos, other files) if not sent using OTP One-Time Key encryption, at least two of the sub-pads may be comparatively larger in size. Based on observing network wide message size data (and optionally specific message size history between two users or a group of users who have exchanged pads), the one-time pad system would be able to optimize sub-pad sizing for future key exchanges to best fit the observed patterns of the network or that specific set of users. It is also advantageous that the one-time pad system uses an efficient mechanism for managing subsequent one-time pad exchange, namely that the same numbering system is used for subsequent sub-pad exchanges so that that the older sub-pads and newly-exchanged sub pads can coexist efficiently and without any additional coordination (in the case where two or more sub-pads having the same number could be used to encrypt a message, the app can choose the older sub-pad by rule, or use an efficiency algorithm to determine the best pad to select for encryption). This mechanism maximizes the utilization of one-time pads, minimizes waste, and eliminates the need to delete or otherwise coordinate/index/manage existing sub-pads during future exchanges.

According to various embodiments, the one-time pad system also uses an advantageous key location mechanism to find the appropriate random data to use for decryption of a particular message. Specifically, at the time of key-exchange, following the generation of a preset amount of random data to serve as a sub-pad, the one-time pad system then generates 32 random bytes to be used as an HMAC key for that sub-pad (stored in the database together with the sub-pad), and X random bytes to serve as the “Key ID” for that sub-pad. When sending a message with this embodiment, the one-time pad system (a) encrypts the plaintext using a key which is identified by the Key ID and an “Offset Value” (a specific number of bytes calculated from the front of the sub-pad), which serves as pointer to a specific location within the sub-pad where the random data used to encrypt the message can be found, (b) pre-pends the Key ID and the Offset Value to the ciphertext, and (c) authenticates the ciphertext using the HMAC key for that sub-pad for integrity checking. The value of X is currently anticipated to be 4 bytes to ensure “likely-unique” identification, but that value can be optimized/adjusted over time. The sending user, upon successful encryption of a message above, generates and stores a random 8 byte Message ID that is not related to the Key ID, which is used for detecting duplicate messages. The receiving user, upon receipt of a message, (i) reads the first 4 bytes of the ciphertext to determine if the Key ID matches a Key ID on the receiving user's device (if not, the message is discarded), (ii) validates the integrity of the message by using the HMAC key that corresponds to the respective Key ID (if not valid, the message is discarded), (iii) reads the second 4 bytes of the ciphertext to determine the Offset Value for the message, (iv) uses the Offset Value to locate (within the sub-pad identified by the Key ID) the random data to be used to decrypt the message, such key the “Message Key,” whose length is determined by the precise length of the ciphertext (not including the pre-pended Key ID and Offset Value) (v) uses the Message Key to decrypt the message. This method has the advantage of more efficient processor usage and not exposing sections of the sub-pad as metadata.

Upon completing decryption, the receiving client writes Message ID value into a local database to enable rapid detection of duplicate messages and potentially corrupted/malicious messages. The Offset Value identifiers enable reliable and efficient decryption of messages with minimal computing overhead and completely without central server coordination. Many one-time pad encryption systems require pad indexing and synchronization of specific pointer addresses and location IDs in order to identify the part of the pad which the receiver should use to decrypt a particular message, which adds complexity and additional points of failure to such systems in addition to requiring significant amounts of client-server communication and coordination which limits scalability of such systems. In contrast, the “Offset Value” system of Message Key identification used by one-time pad system is more scalable (does not require indexing, pointer information exchange, or any centralized coordination) and more tolerant of potential pad file inconsistencies.

In addition to the key Identification and message identification systems, the one-time pad system also employs an advantageous pad management system, where, upon successful encryption (or decryption) of a message using a particular Message Key, that Message Key location within the sub-pad is written over by 0's to delete the key that has already been used, but to preserve location data within the sub-pad to enable future identification of future Message Keys using the Offset Value system.

The one-time pad system also contemplates including a message authentication code (MAC) of the ciphertext of a message to provide for message integrity authentication, either through SHA256 hashes using a previously-exchanged 256 bit HMAC key (these keys are generated and stored at the time of key exchange) associated with the sub-pad being used to encrypt a particular message or through the use of a one-time MAC using part of the one-time pad data, optionally, from the same sub-pad as the message, an HMAC 256 bit key or a One-time MAC key, hereinafter referred to as a MAC Key. Message integrity checking and authentication is particularly critical in the one-time pad system to ensure that the ciphertext has not been tampered with in transit, and to ensure that for messages that fail to authenticate correctly, decryption will not be attempted and the “suspect” message will be discarded. The one-time pad system may optionally include an option under “Advanced Settings” to enable the user to choose to use one-time MACs for message authentication and integrity checking (albeit with a higher rate of one-time pad data consumption when sending messages).

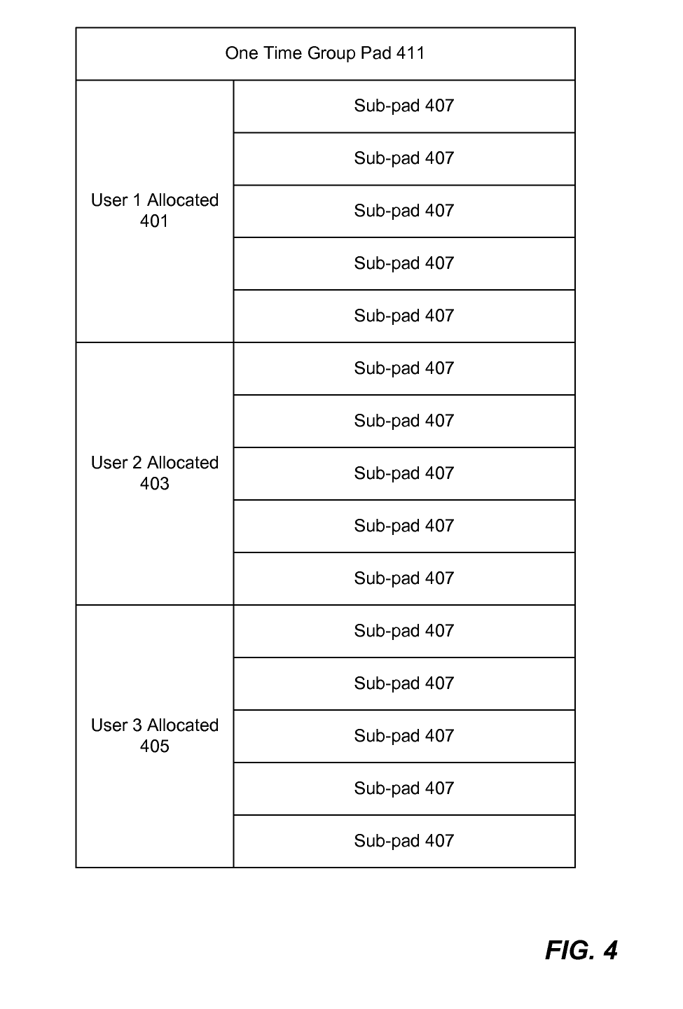

FIG. 4 illustrates one example of group pad usage. Group pads can be used to allow groups to securely send and receive messages to and from one another more efficiently than using a collection of bilateral pads and routing configurations to support messaging in a group context. A mechanism for preventing pad collision is desirable. According to various embodiments, the sub-pad allocation system (though other deterministic and random mechanisms could be implemented) includes dividing the total number of sub-pads by the number of users in the group, assigning each user a corresponding initial subset of sub-pads, and assigning an order of access of sub-pads such that each user “claims” sub-pads as “send pads” in a deterministic fashion that can be known to the other users in the group (such as a star configuration where each user claims sub-pads moving toward the center). One implementation of a group pad 411 includes sub-pads 407 allocated to different users. Block 401 is allocated to User 1, block 403 is allocated to User 3, and block 405 is allocated to User 3. To the extent a user exhausts the initial sub-pad subset allocation, the user would then claim a sub-pad at 407 that would be the last sub-pad claimed (i.e. the one at the bottom of that user's sub-pad stack) by the user who has the most unused sub-pads allocated. In this way, sub-pads can be allocated without central server coordination and without requiring real-time, online coordination among user's clients.

Sub-pad claiming can also be done (whether in a deterministic fashion or randomly) with an announcement system such that (a) each sub-pad claiming would be preceded by a message to the group stating such intention to claim such sub-pad, at which point, other users' clients could object (on the basis that they are claiming a sub-pad), and/or (b) each sub-pad claiming by a user would be announced immediately at the time of claiming such that other users would recognize that sub-pad as “receive pad” for them. Again, it should be noted that this system is optional since immediately upon receipt of a new message encrypted using a particular sub-pad, each receiving user will automatically recognize that sub-pad as “receive pad” for them.

In the event of new users joining the group, the system could recalculate the allocation of remaining unclaimed sub-pads, then reassign a subset of those unclaimed pads to the new user (either based on an equal weighting, or taking into account the historical sub-pad consumption data). Users forming or joining a group would be initially allocated a small sub-pad as a “send pad” to identify the user establish the user's position in the sub-pad claiming process. Users in a group could be anonymous to each other, have known identities, or any combination of anonymous and non-anonymous. Unlike recently developed “anonymish” applications that enable sharing on a quasi-anonymous fashion, any messages sent to the group would only be readable by the members of that group and not by the company operating the system. Groups can be either administered by a user or group of users (who would invite/allow/approve new users), be dynamically democratically managed, or be entirely unmanaged.

Replenishment of group pads can be accomplished via a group meeting, group pad delivery, or potentially, using individual bilateral unique AES 256 bit keys and MAC Keys. Unallocated sub-pads within a group pad could optionally be claimable by clients as bilateral sub-pads in which case the sender would claim the sub-pad as a “send pad” and notify the receiver that the sub-pad is now a bilateral “receive pad” for that user, and also notify the other members of the group that the sub-pad is no longer part of the group pad and that it should be deleted from their system. Additionally, in order to remove the pad from devices of the other members of the group, the claimer of the sub-pad could send messages to each of the other members (other than the new bilateral receiver) using such sub-pad that would cause that sub-pad to be deleted from the devices of the other (non-bilateral receiver) members of the group. This process could be made invisible to the users by having the deletion messages contain some control code metadata that would indicate the message as “pad management metadata” rather than an actual message.

Some one-time pads can be configured as broadcast or multicast pads, where one user or a group of users has send capability and the rest of the users are in “receive only” mode. This can be provisioned centrally within an enterprise in the context of mobile device management policies, together with compliance features. This can be useful for group notification applications or for enabling future communications with large groups of people who are attending an event, such as a conference, festival, concert or other cultural event. Attendees could receive a one-time pad on their device which would enable secure access to content designed to be shared during or after an event (presentations, audio & video recordings, etc.). The ability to receive a one-time pad could be tied to a ticket or ticketing system such that only specified (premium, VIP, etc.) holders of a ticket would be entitled to receive a one-time pad to gain secure access to the content. This can function as a form of DRM where only people physically present and able to receive the one-time pad are entitled to access certain content. Since users always have the ability to delete any particular key and thus terminate the corresponding sender's ability to send messages to the user, the user is in complete control of what messages the user wants to receive. In the case of “receive only” mode, this ability to permanently and definitively unsubscribe from messages from a sender could lower the barrier for users to subscribe to content messages since they do not have to provide any personal details and can unsubscribe without fear of continuing to receive messages. The one-time pad system could charge fees to users who want to use “receive only” mode for their purposes.

According to various embodiments, one-time-pad “delivery” is allowed via trusted courier/third party. For users in disparate geographic locations that do not have an opportunity to meet in person, one-time pad system can enable a one-time-pad delivery capability, where a user would generate a one-time-pad and a unique 256 bit key to share with the remote user, then encrypt the one-time-pad (and AES key) with the public key of the remote user (which is generated by the client app of the remote user), then authenticate the encrypted message with a MAC, then transfer the pad locally to a trusted third party (with whom the user has already exchanged a shared key) using the unique AES 256 bit key and 256 bit HMAC key shared with that third party to secure the transmission over the Local Wireless Connection. Once the third party meets the remote user in person, they securely exchange a shared key (if they have not already), and using their unique shared AES 256 bit key and 256 bit HMAC key, the third party transmits the encrypted and authenticated one-time-pad (and AES key) to the remote user, who then authenticates the one-time pad using the HMAC key, decrypts the one-time-pad and AES key using his private key and is now able to communicate with the other user. Optionally, the authenticated and encrypted pad being sent via the original user could contain metadata about the third party and/or the remote user such as biometric data, photograph, shared secret PIN code, etc. Optionally, the authenticated and encrypted pad in transit could allow FedEx style tracking for audit trails or for gameification, including even enabling local “homing” via functionality like “Find your Friends.”

Optionally, the pad delivery system could incorporate “transfer fees” or specific bounties for pad delivery. A “teleporter” system could also be implemented to ease pad transfer over long distances, by having either one-time pad system-managed or third party operated pad drops that could optionally use biometric identification mechanisms or two factor authentication.

Users' “friends” on the one-time pad system network could be securely identified. In particular embodiments, the one-time pad system network is operated to maximize utility and ease of use for users, while still achieving perfect security for message communication between and among devices. The one-time pad system network may optionally require an email address for unique identification (and communications to users) and may also use telephone numbers or other unique IDs for discoverability purposes.

According to various embodiments, potential exists for a completely anonymous version of the one-time pad system network. The one-time pad system platform could be used to operate a network that is partially or entirely anonymous. Partial anonymity could be achieved by enabling some users (potentially as a premium feature) to register as a user with no personally identifiable information. Additionally, an instance of the one-time pad system network could also be operated on a 100% anonymous basis with no personal information and no “find your friends” capabilities. The anonymous version of the network could still enable routing configurations and otherwise offer the same provable security for network communications and authentication of validity of messages. The relative autonomy of the clients' behavior among themselves would limit the amount of metadata sent to the one-time pad system server. In the extreme, the one-time pad system platform could also enable perfect security for messages even sent via bittorrent, TOR, bitMessage, or even UseNet newsgroups, removing the one-time pad system server from the message delivery process and further enhancing anonymity. Various implementations are made possible by the unique and autonomous behavior of the one-time pad system client. In fact, the one-time pad system server could be eliminated or replaced with another transport/delivery mechanism with no detriment to the security of the messages (true for both past and future messages).

A trusted network for secure communications could serve as a foundation for a secure social network. Since users who communicate with each other in the one-time pad system have physically met and exchanged keys, each user's network of connections constitutes a uniquely trusted and secure network where users are virtually certain of each other's identities. Unlike traditional social networks where connections are made online only and without definitive or even rigorous identity authentication, the one-time pad system network is truly a community of trust. One can imagine that such a network of trust, combined with provably secure communications between and among the users, could form the basis of a new category of social network, where identities of the users are known to only the other users and content is only readable by those users.

Fine grained customization preferences for a one-time pad system allow the system to suit a wide range of users. The one-time pad system app may optionally allow users to set and adjust the settings to meet their particular needs and preferences, making the system equally useful to students (e.g. sharing photos that they do not want to be public) and to bankers (engaged in highly confidential, potentially market-moving acquisition negotiations). For sending preferences, users could optionally choose (1) whether their messages will be visible (“timeline style”) in recipients' one-time pad system apps by default, or whether they need to be clicked on to view, (2) whether or not their messages will be automatically deleted after a customizable period of time, (3) whether recipients would be permitted to save photos, videos, and/or files to their device, (4) whether message text is permitted to be copied or forwarded, (5) whether they want to show online, last seen, “is typing,” and “message read” status messages by default or only for particular users, (6) whether or not to allow automatic “local discovery” by contacts in their contact list who are one-time pad system users, (7) whether or not to use a password or fingerprint sensor to protect access to the one-time pad system app or specific sections (such as sent messages), (8) whether or not to keep a log of sent messages or delete them right away, etc. These kinds of settings could be optionally globally set for the sender or the sender can set permissions and preferences for different groups of users separately, such that family pictures distributed to family members would be afforded less on-device protection than sensitive business documents shared with colleagues. Users would also optionally be able to set similar preferences for default message receiving and display behavior on their own device, but in all cases, a message sender's settings have precedence (e.g. a message from a sender who has “click to view” set for messages will be “click to view” even in a receiving user's device who has receiving preferences set to “timeline style”). Enabling users to deeply customize their settings for security and message treatment makes the system useful for the widest possible audience and does not limit its appeal or usefulness to the security-obsessed or the casual user.

A one-time pad system network can also allow for enhanced game mechanics. To encourage active usage of the one-time pad system network, usage leaderboards and virtual badges may be used to incent users to share one-time pad system with their friends. Additionally, prizes could be awarded for the most connected users each month, and virtual currency could be earned by users in exchange for taking certain actions in the app. Leaderboards can contain usernames, anonymous IDs or a mix of the two and can be calculated globally, within a user's network, in a local geo area, etc.

A one-time pad system plug in could allow usage for traditional email clients. The one-time pad system technology platform could also be used to secure email communications between two users who can meet in person to exchange AES 256 bit keys, MAC Keys, and, optionally, a one-time pad. This could be implemented as a stand-alone plugin to work with email client software (mobile, desktop and web-based) to dramatically simplify the implementation of encryption capability for email compared to expensive, complex, time-consuming and massively frustrating existing options for securing email (using signed digital certificates). Reducing the complexity of implementing secure encryption to a simple QR code scan could dramatically increase adoption and use of encryption for email communications in addition to messaging communications via the one-time pad system network.

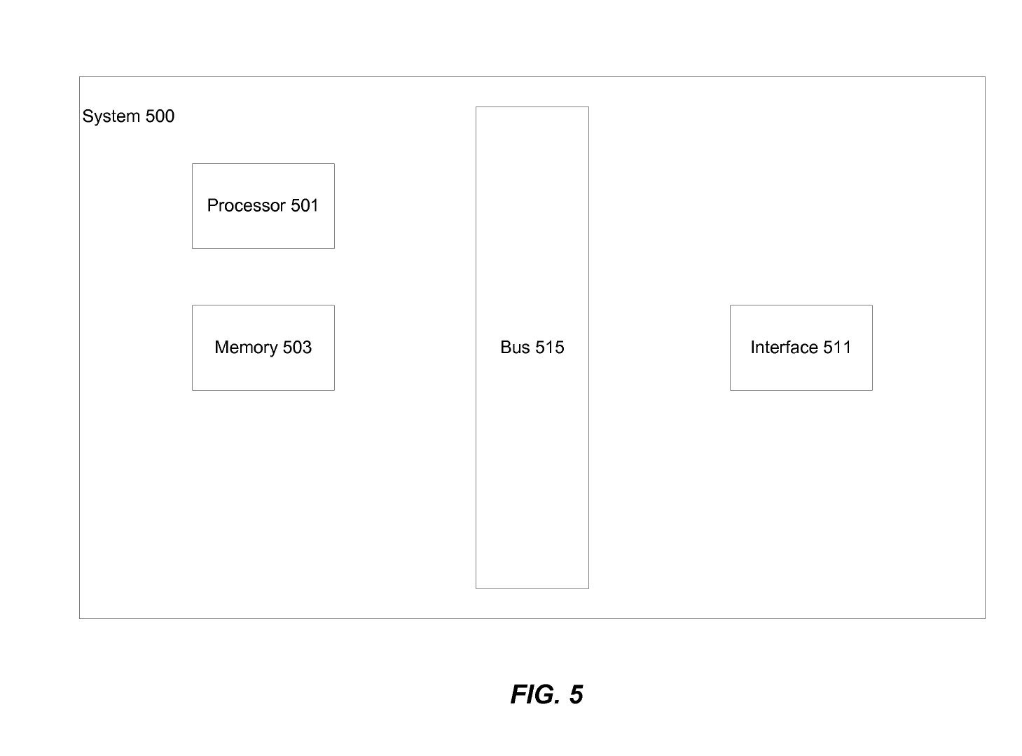

FIG. 5 illustrates one example of a device or system. According to particular embodiments, a device 500 suitable for implementing particular embodiments of the present invention includes a processor 501, a memory 503, an interface 511, and a bus 515 (e.g., a PCI bus or other interconnection fabric) and operates as a mobile device. The mobile device may also include other components such as a battery, accelerometer, camera, magnetic sensor, gyroscope, relative humidity sensor, ambient temperature sensor, proximity sensor, orientation sensor, random number generator and/or pseudo random number generator, microphone, and gravity sensor. When acting under the control of appropriate software or firmware, the processor 501 is responsible for performing key exchanges and generating one-time pads. Various specially configured devices can also be used in place of a processor 501 or in addition to processor 501. The interface 511 is typically configured to send and receive data packets or data segments over a network.

Particular examples of interfaces supported include Wifi, Bluetooth, USB, optical, and infrared interfaces as well as other high speed and wide area network interfaces. Generally, these interfaces may include ports appropriate for communication. These interfaces may be accessed by higher level system services such as MultiPeer on iOS (which uses a combination of Bluetooth and Wifi to establish peer-to-peer device connections) and Wi-Fi Direct on Android (which uses a direct Wifi to establish peer-to-peer device connections). In some cases, they may also include an independent processor and, in some instances, separate memory. The independent processors may control such communications intensive tasks as packet switching and packet transmission.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
conducting a key exchange between a first device and a second device by using an optical camera based communication mechanism;
generating a one-time pad using random number generation at the first device;
encrypting the one-time pad using a key obtained as a result of the key exchange between the first device and the second device by using the optical camera based communication mechanism, the one-time pad encrypted at the first device;
sharing the encrypted one-time pad with the second device, wherein the second device is operable to use the one-time pad upon decrypting the one-time pad.

2. The method of claim 1, wherein the key is one of a shared key or a public key.

3. (canceled)

4. The method of claim 1, wherein the key exchange is a close proximity key exchange.

5. The method of claim 1, wherein the key exchange is conducted using an optical camera on the second device scanning a Quick Response (QR) code on a display of the first device, wherein the QR code provides a unique, randomly-generated AES key.

6. (canceled)

7. The method of claim 5, wherein the QR code provides a public-key from a public-key, private-key pair.

8. The method of claim 5, wherein the QR code further provides a MAC Key for authenticating the integrity of the payload.

9. The method of claim 8, wherein the QR code further provides a single-use session token.

10. The method of claim 9, wherein the QR code further provides a username and metadata.

11. The method of claim 9, wherein upon scanning the QR code, the second device uses the single-use session token to request the key from the first device.

12. The method of claim 11, wherein the first device verifies the single-use session token from the second device and generates a one-time pad.

13. The method of claim 12, wherein the first device encrypts the one-time pad and sends the encrypted one time pad to the second device.

14. The method of claim 7, wherein the QR code further provides a MAC Key for authenticating the integrity of the payload.

15. The method of claim 14, wherein the QR code further provides a single-use session token.

16. The method of claim 14, wherein the QR code further provides a username and metadata.

17. The method of claim 15, wherein upon scanning the QR code, the second device uses the single-use session token to request the key from the first device.

18. The method of claim 17, wherein the first device verifies the single-use session token from the second device and generates a one-time pad.

19. (canceled)

20. A system comprising:
an optical camera configured to conduct a key exchange between a first device and a second device by using an optical camera based communication mechanism;
a processor configured to generate a one-time pad using random number generation at the first device and encrypt the one-time pad using a key obtained as a result of the key exchange between the first device and the second device by using the optical camera; and
an interface configured to share the encrypted one-time pad with the second device, wherein the second device is operable to use the one-time pad upon decrypting the one-time pad.

21. (canceled)

22. The system of claim 20, wherein the key exchange is conducted using an optical camera on the second device scanning a Quick Response (QR) code on a display of the first device.

23. (canceled)

24. (canceled)

25. (canceled)

26. (canceled)

27. (canceled)

28. The system of claim 22, wherein the QR code provides a public key from a public-key, private key pair.

29. (canceled)

30. (canceled)

31. (canceled)

32. (canceled)

33. An apparatus comprising:
means for conducting a key exchange between a first device and a second device by using an optical camera based communication mechanism;
means for generating a one-time pad using random number generation at the first device;
means for encrypting the one-time pad using a key obtained as a result of the key exchange between the first device and the second device by using the optical camera based communication mechanism, the one-time pad encrypted at the first device; and
means for sharing the encrypted one-time pad with the second device, wherein the second device is operable to use the one-time pad upon decrypting the one-time pad.
